(19) United States
(12) Patent Application Publication
(10) Pub. No.: US 2006/0006789 A1
(43) Pub. Date: Jan. 12, 2006

(54) Electron-beam excited light-emitting devices

(76) Inventors: Shigeo Itoh, Mobara-shi (JP); Hitoshi Toki, Mobara-shi (JP); Hirokazu Takanashi, Mobara-shi (JP); Hisamitsu Takahashi, Mobara-shi (JP); Yoshitaka Sato, Mobara-shi (JP); Kazuhiko Itakura, Mobara-shi (JP); Takuya Hamada, Mobara-shi (JP); Takao Shiraga, Mobara-shi (JP); Kiyoshi Tamura, Mobara-shi (JP); Tatsuo Yamaura, Mobara-shi (JP)

Correspondence Address: QUARLES & BRADY LLP, 411 E. WISCONSIN AVENUE, SUITE 2040, MILWAUKEE, WI, 53202-4497, US

(21) Appl. No.: 10/887,050

(22) Filed: Jul. 8, 2004

(51) Int. Cl. H01J 1/62

(52) U.S. Cl. 313/497

(57) ABSTRACT

A fluorescent display tube is provided, which employs a non-evaporation type getter, instead of the evaporation-type Ba getter, whereby the serviceable life of the fluorescent substance containing SrTiO3 as a base component is prolonged. At least one or more elements selected from the group consisting of Zr, V, Fe, Ti, Ma, Mn, and La are used for the getter for fluorescent display tubes, each which employs a fluorescent substance containing SrTiO3 as a base component. This feature allows carbon series residual gases remaining in the tube to be removed, so that the serviceable operation can be prolonged.

### CROSS REFERENCES TO RELATED APPLICATIONS

Not Applicable

### STATEMENT REGARDING FEDERALLY SPONSORED RESEARCH

Not Applicable

### BACKGROUND OF THE INVENTION

The present invention relates to electron-beam excited light-emitting devices, such as fluorescent display tubes (VFDs) and field-emission-type displays (FEDs), each being operated on a low anode voltage of 1 kV or less. Particularly, the present invention relates to an improvement of the brightness life characteristics of electron-beam excited light-emitting devices, each of which uses SrTiO3 as a base material of a fluorescent substance coated on an anode.

A fluorescent display tube, which is an example of prior art electron excited light emitting devices, includes electrodes arranged inside a flat box-like envelope. The envelope is formed of an anode substrate made of a plate glass, a front substrate confronting the anode substrate, and a frame, made of side plates, which is disposed between the anode substrate and the front substrate. The electrodes correspond to an anode conductor formed over the inner surface of the anode substrate, an anode formed of a fluorescent substance layer coated on the surface of the anode conductor, a mesh-like grid disposed above the anode, and a filament-like cathode disposed above the mesh-like grid. The inside of the envelope is evacuated by a vacuum pump to create a vacuum through an evacuation hole or tip disposed in the envelope. Thereafter, the envelope is hermetically sealed to maintain a high vacuum in the envelope.

The fluorescent display tube is operated and light emitted, that is, electrons are emitted from the cathode and are controllably accelerated with the grid. Thus, the electrons impinge against and illuminate the fluorescent substance layer overlying the anode. However, the electrons may strike portions other than the fluorescent substance layer. For example, when the electrons rush into the space between fluorescent substance particles, or strike the mesh-like grid or the inner surface of the envelope, the residual gases adhered thereto are released out. A getter is disposed inside the envelope to adsorb the residual gases so that the vacuum inside of the envelope is maintained.

As to the conventional getters, a getter material, such as Ba or Al alloy, is filled in a metal getter container. The getter container is firmly welded to the getter mounting tub, which is attached to the cathode support inside the envelope. A vacuum pump evacuates the gas in the envelope and carbon dioxide gas released due to the flushing of a filament-like cathode. Thereafter, the envelope is hermetically sealed. After this process, the getter container is heated using high frequency induction heating to evaporate the getter material Ba within the getter container. Thus, the Ba getter film is formed over an inner surface of the envelope. The getter film adsorbs the residual gases. As described above, the conventional getter for a fluorescent display tube is called an evaporation-type getter because a getter film is formed over a wall surface inside an envelope by evaporating the getter material.

Fluorescent substances of various types coated on the anode, each of which emits light at a low voltage, have been used. A fluorescent substance of ZnO:Zn is generally used broadly for green color. However, a SrTiO3 based fluorescent substance, e.g. SrTiO3:Pr,Al, invented by the present inventors, is well known (for example, refer to Japanese Patent Laid-open Publication No. Tokkai-hei No. 8-85788).

As to the use of the SrTiO3:Pr,Al fluorescent substance in fluorescent display tubes, it is known that a brightness deterioration phenomenon occurs, i.e., the brightness of the device has a high value initially, but it reduces gradually over a continuous operation of several tens of hours. However, it is also known that when a continuous illumination test is carried out in a vacuum chamber, which is continuously evacuated by a vacuum pump, the above-mentioned brightness deterioration phenomenon does not often occur. Accordingly, it is considered that one cause of the brightness deterioration phenomenon may be the influence of the residual gases within the fluorescent display tube. For that reason, in order to overcome the brightness deterioration phenomenon, it has been proposed that a metal oxide protective film is formed on the surface of the fluorescent substance to prevent the influence of the residual gases (for example, refer to Japanese Patent Laid-open Publication No. Tokkai-hei 8-283709).

Forming a protective film on the surface of the fluorescent substance which solves the brightness deterioration phenomenon has proven difficult. It is difficult to control the thickness of the protective film because a metal oxide protective film is formed on the surface of a fluorescent substance. A thin protective film leads to reducing the effect of improving the brightness deterioration. A thick protective film leads to shielding the luminous of the fluorescent substance, thus reducing the brightness. When a small amount of a fluorescent substance is formed experimentally, the protective film is easily formed uniformly on the fluorescent substance. However, in a mass production, it is difficult to form a thick protective film uniformly on all the fluorescent substance particles. Therefore, the conventional brightness deterioration countermeasure was not suitable in the mass production.

In order to determine the cause of the brightness deterioration phenomenon, the present inventors analyzed the surface of a SrTiO3:Pr,Al fluorescent substance, which has been continuously illuminated in a fluorescent display tube, and the surface of a SrTiO3:Pr,Al fluorescent substance, which is in a non-illumination portion (i.e. it is not continuously illuminated) within a fluorescent display tube. The analysis was carried out using an X-ray photoelectron spectroscopy (ESCA). The results are shown in FIG. 1.

As shown in FIG. 1, the fluorescent substance in the non-illumination portion has a peak range of 285 eV to 286 eV, which corresponds to a C—H bond and a C—O bond. The continuously illuminated fluorescent substance has a peak range of 285 eV, which corresponds to a C—C bond. In other words, it was found that a carbide such as CO, CO2, C2H2, CH4, or the like, exists in the surface of the fluorescent substance in the non-illumination portion, but an amorphous carbon C exists in the surface of the fluorescent substance that was continuously illuminated.

A gas analysis was carried out to determine what kinds of gas will be released when the fluorescent display tube is energized. FIG. 2 is a graph indicating analysis values of residual gases before a fluorescent display tube is operated and analysis values of gases released when the fluorescent display tube is energized. In the SrTiO3:Pr,Al fluorescent substance shown in FIG. 2, the internal pressures of a carbon composition (such as CO, CO2, or CH4), H2, and H2O increase during an energized state, compared with the internal pressure of the residual gases in the tube. Accordingly, it was found that those gases are released during electric conduction.

Based on the above-mentioned results, the mechanism that deteriorates brightness due to the residual gases released from the SrTiO3:Pr,Al fluorescent substance is considered as follows.

The Ba getter film adsorbs the gases CO, CO2, and H2O, remaining in the fluorescent display tube. The residual gases reacts with Ba according to the following reactive formulas (1), (2) and (3) (or through the primary reaction) to combine with a Ba compound such as BaO or BaC2. As a result, the Ba compound is chemically adsorbed.
2CO+3Ba→2BaO+BaC2 (1)
2CO2+5Ba→4BaO+BaC2 (2)
H2O+Ba→BaO+H2↑ (3)

However, when H2O exists in the display tube, BaC2 combined through the formulas (1) and (2) combines with H2O according to the reaction formula (4) (or through the secondary reaction) to create C2H2. Moreover, C2H5 reacts with H2 according to the reaction formula (5) (or through the tertiary reaction) to create CH4.
BaC2+H2O→BaO+C2H2↑ (4)
C2H2+3H2→2C2H4↑ (5)

As described above, even when the Ba getter is placed in the display tube, carbide series gases, such as CO, CO2, and CH4, exist and bond with Sr on the surface of the SrTiO3 fluorescent substance overlying on the anode. It is assumed that such a bond is not stronger than the chemical bond making a chemical compound with Sr but that the carbide gas is physically adsorbed with Sr. When the display tube is illuminated and driven, electron beams emitted from the cathode hits the SrTiO3 fluorescent substance. The physically absorbed carbide series gases are decomposed by the energy of the electron beams. Thus, the amorphous carbon is deposited on the surface of the fluorescent substance. As a result, it has been assumed that the carbon, which bypasses the electron beam excited energy transfer mechanism, makes it difficult to transfer the electron beam excited energy directly to the fluorescent substance so that the luminous efficiency decreases.

### SUMMARY OF THE INVENTION

The present invention is made to solve the above-mentioned problems.

An object of the invention is to provide an electron beam excited light emitting device, which uses a SrTiO3 fluorescent substance and which has an improved serviceable life in brightness. The light emitting device employs a getter that can adsorb carbide series gases remaining therein, without using the Ba getter that causes release of carbide series gases.

In an aspect of the present invention, an electron beam excited light emitting device comprises a vacuum envelope containing a getter for maintaining a degree of vacuum; cathodes, each of which emits electrons; and anodes having coated thereon a fluorescent substance, which light-emits when the electrons strike the substance. The fluorescent substance is SrTiO3 acting as a base component thereof. The getter contains at least one or more elements selected from the group consisting of Zr, V, Fe, Ti, Mg, Mn, and La.

More specifically, the fluorescent substance acting as a base component is SiTiO3 including SrTiO3:Pr and SrTiO3:Pr, Al. The getter comprises a non- evaporation-type getter. The cathode may be either a filament-like oxide cathode or a field emission-type cathode.

The electron beam excited light emitting device further comprising a grid arranged between the cathode, which emits electrons, and the anode having a fluorescent substance coated thereon which emits light when the electrons strike the fluorescent substance.

### BRIEF DESCRIPTION OF THE DRAWINGS

This and other objects, features, and advantages of the present invention will become more apparent upon a reading of the following detailed description and drawings, in which:

FIG. 1 is a graph plotting results of a ESCA analysis of a non-illumination portion and a continuous illumination portion of a SrTiO3 fluorescent substance;

FIG. 2 is a bar graph showing analysis values of residual gases in a fluorescent display tube, which uses a SrTiO3 fluorescent substance, and analysis values of gases released in conduction;

FIG. 3 is a graph plotting results of life tests of a conventional fluorescent display tube and a fluorescent display tube of the present invention, each of which uses a SrTiO3 fluorescent substance; and

FIG. 4 is a cross-sectional view illustrating the major portion of a fluorescent display tube according to the present invention.

### DESCRIPTION OF THE EMBODIMENTS

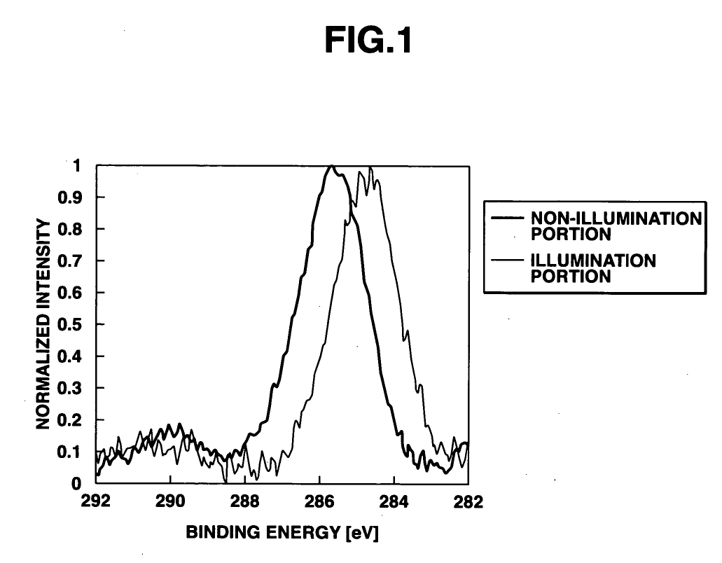

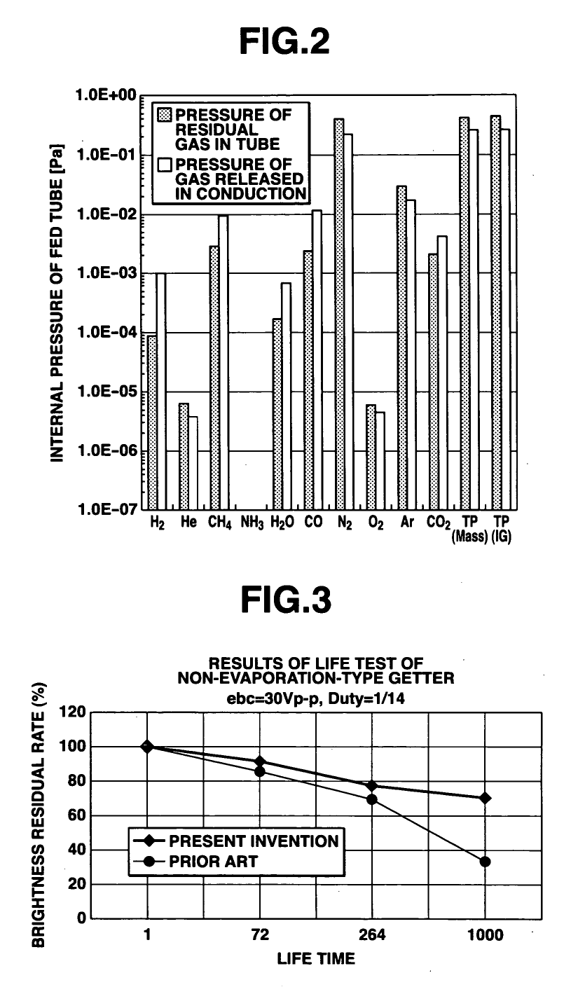

An electron beam excited light emitting device, such as a display tube, according to an embodiment of the present invention, will be described below by referring to FIGS. 1 to 4.

The present inventors focused their attention on Zr, V, Fe, Ti, Mg, Mn, and La as a getter material to be used in the present invention. It has been know that each of those metals or alloys thereof adsorbs gases when the surface thereof is thermally activated. The getter material may be shaped in various forms such as a strip or ring form. A strip getter was employed in the present invention.

The getter is heated at 500° C. for 10 minutes under a vacuum maintained at 10⁻⁴ torr or less in order to sufficiently activate the surface of the getter. With temperatures below 500° C., activation can be carried out by prolonging the heating time. Because the gettering action can be obtained by merely heating without evaporating in a vacuum space, the getter of this type is called a non-evaporation type getter.

The getter may be heated using methods known in the art, such as by high-frequency induction heating, by flowing electrical current through the metal base of the getter, by heating with a laser beam, using an infrared lamp from outside the envelope, and the like, without departing from the scope of the invention. Moreover, in the fluorescent display tube fabrication process, when the sealing is carried out through external heating to easily release gases, the corresponding heat may be utilized for the heating of the getter. In either case, the degree of vacuum inside the envelope forming the display tube is maintained below 104 torr to activate the getter.

As to the non-evaporation type getters, the surface of the getter chemically adsorbs the residual gases, such as CO, CO2, CH4, H2, and H2O, in the display tube after it has been activated though heating. The getter may be disposed at any portion within the envelope of the display tube. However, in the present invention, it is preferable that the getter is attached close to an anode disposed in the envelope to chemically adsorb the residual gases before they adhere to the anode.

### Embodiment 1

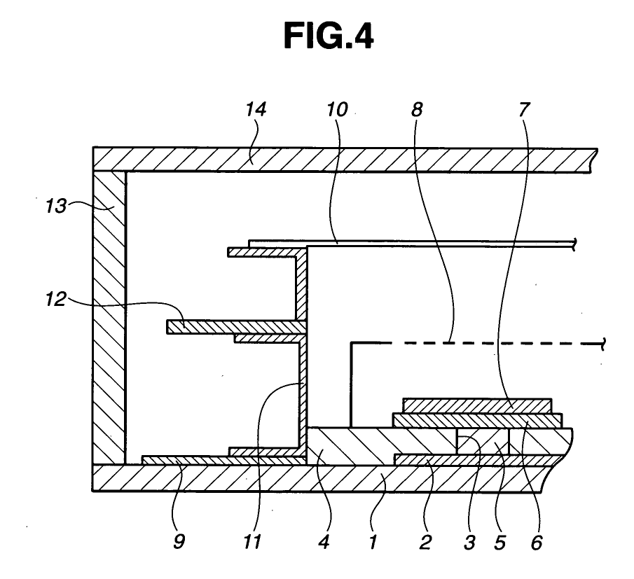

A fluorescent display tube incorporating the present invention will be described below by referring to FIG. 4.

In a photolithographic process, a wiring conductor 2 (of an aluminum thin film) is formed in a wiring pattern on the inner surface of an anode substrate 1 (or a plate glass) forming part of a flat box-like envelope. An insulating layer 4 is laminated over the substrate 1 through a thick film printing process which forms a through hole 3 corresponding to the position leading to the wiring conductor 2. Next, the through hole 3 is filled with a conductive paste 5 through the thick film printing process. Thereafter, an anode conductor 6 is formed through the thick film printing process. A SrTiO3:Pr,Al fluorescent substance 7 is coated on the surface of the anode conductor 6 through a screen printing process.

A mesh grid 8 is disposed above the anode substrate 1 and at the position where the mesh grid 8 conducts with the wiring conductor 2. Cathode supports 9, made of a metal plate, are disposed on both the ends of the anode substrate 1. An anchor support is firmly fixed to the cathode supports 9 to sustain the filament-like cathode 10.

A getter mounting tub 11 is mounted to attach the getter. A getter 12 is securely welded to the getter mounting tub 11. The anode substrate 1 is covered with a box-like container, formed of side plates 13 and a front plate 14, which are sealed to each other with an adhesive agent. Thereafter, the completed envelope is evacuated to create a vacuum therein.

Next, the getter will be explained below in detail.

The present inventors were interested in St121 and St122 getters made by SAES Getters SpA, Milan, Italy. The St121 getter is made of Ti and Zr—Al alloy and the St122 getter is made of Ti and Zr—V—Fe alloy. Either getter can remove residual gases, such as CO, CO2, CH4, H2, H2O, through chemical absorption. Advantageously, the St121 getter is not significantly damaged even if when heated in air.

In the fabrication process, after the getter 12 is attached, the fluorescent display tube is subjected to heating steps, such as a sealing step and an evaporation step. Even after being heated once, through re-activation the St121 getter can regain its original adsorption properties equivalent to that of a new getter. For that reason, the St121 getter is suitable for use in fluorescent display tubes. Accordingly, the St121 getter was used in fluorescent display tubes employing a SrTiO3:Pr,Al fluorescent substance. By using a getter containing at least one or more elements selected from the group consisting of Zr, V, Fe, Ti, Mg, Mn, and La, the same effect as that of the St121 can be expected.

A second fluorescent display tube, which has the same fabrication requirements as those of the present embodiment but uses a conventional Ba getter, was fabricated as a comparative example.

The fluorescent display tube of the present embodiment and the fluorescent display tube of the comparative example were subjected to a life test. FIG. 3 is a graph plotting brightness survival rates versus continuous illumination time. With the illumination of 1000 hours, the brightness survival rate of the fluorescent display tube using the conventional Ba getter dropped to 30%. However, the brightness survival rate of the fluorescent display tube using the Ti and Zr—V—Fe getter in the present embodiment was 65%. That is, the survival rate is improved twice or more, compared to the conventional Ba getter.

The fluorescent display tube according to the embodiment of the present invention has been explained. However, as to the field emission type displays (FEDs) employing field emission type cathodes (FECs), the getter containing at least one or more elements selected from the group consisting of Zr, V, Fe, Ti, Ma, Mn, and La may be employed for FEDs employing a SrTiO3:Pr,Al fluorescent substance. As a result, the operational life of the FED can be prolonged.

As described above, the getter containing at least one or more elements selected from the group consisting of Zr, V, Fe, Ti, Mg, Mn and La was used for the fluorescent display tube or the field emission type display, which employs a SrTiO3 based fluorescent substance. Accordingly, the fluorescent display tube or the field emission type display, which has a small drop in brightness even in continuous illumination and which has a largely improved operational life, can be provided effectively.

What is claimed is:

1. An electron beam excited light emitting device, comprising a vacuum envelope, said vacuum envelope containing:
a getter for maintaining a degree of vacuum, said getter containing at least one or more elements selected from the group consisting of Zr, V, Fe, Ti, Mg, Mn, and La;
a cathode which emits electrons; and
an anode having a fluorescent substance coated thereon in the path of at least some of said electrons, said fluorescent substance including SrTiO3 acting as a base component.

2. The electron beam excited light emitting device as defined in claim 1, wherein said fluorescent substance being SrTiO3 acting as a base component is SrTiO3:Pr.

3. The electron beam excited light emitting device as defined in claim 1, wherein said fluorescent substance being SrTiO3 acting as a base component is SrTiO3:Pr,Al.

4. The electron beam excited light emitting device as defined in claim 1, wherein said getter comprises a non-evaporation-type getter.

5. The electron beam excited light emitting device as defined in claim 1, wherein each of said cathodes, which emits electrons, comprises a filament-like oxide cathode.

6. The electron beam excited light emitting device as defined in claim 1, wherein each of said cathodes, which emits electrons, comprises a field emission- type cathode.

7. The electron beam excited light emitting device as defined in claim 1, further comprising a grid arranged between said cathode and said anode.
